(19) United States
(12) Patent Application Publication
(10) Pub. No.: US 2025/0060612 A1
(43) Pub. Date: Feb. 20, 2025

(54) Virtual Screen

(71) Applicant: Håkan Guldkula, LONDON (GB)

(72) Inventor: Håkan Guldkula, LONDON (GB)

(21) Appl. No.: 18/721,248

(22) PCT Filed: Jan. 3, 2023
(86) PCT No.: PCT/EP2023/050077

§ 371 Date: Jun. 18, 2024

(30) Foreign Application Priority Data
Jan. 7, 2022 (US) 63266521
May 19, 2022 (SE) 2250598-6

(51) Int. Cl. G02B 30/56

(52) U.S. Cl. CPC G02B 30/56

(57) ABSTRACT

Methods and systems, including computer program products, for creating a virtual screen (208) for displaying a visible image in the air. A virtual screen generator (206) is provided. The virtual screen generator (206) has one or more light sources (302), a scanning means (304) for scanning the light from the light sources (302) across a pre-defined space in air, and a controlling means for controlling the operation of the light sources (302) and the scanning means (304). The virtual screen generator (206) receives image data to be displayed on the virtual screen (208) and uses the controlling means to direct the light from the one or more light sources (302), such that a collection of light-emitting points in the visible range of the electromagnetic spectrum are created within the pre-defined space in the air, which points jointly form an image corresponding to the received image data.

### BACKGROUND

The present invention relates to forming visible images, and more specifically, to forming visible images in a gaseous or liquid medium, such as air or water.

Mobile devices, such as cell phones and tablet computers, are getting evermore pervasive in society. They are used for a variety of purposes, such as taking photos, listening to music or podcasts, searching for information on the Internet, viewing images and videos, and so on. Manufacturers of these devices have to weigh the benefits of portability (i.e., the size of the device) against the usability of the device. This is particularly true when it comes to the screen size of the device, as that is generally one of the main factors affecting the overall size of the device.

In many devices, the user interacts with the device through a touch sensitive screen, which is also used to display information to the user. Since the screen size is limited by the overall size of the device, it may be difficult for a user to read information, for example, on a webpage, or to view images displayed on the screen of a smaller device, such as a cell phone. While most devices allow the user to enlarge the contents being displayed on the screen, this typically results in only a smaller portion of the text or image being visible on the screen at any given time, and the user must scroll or otherwise move the image or text around on the screen, without being able to view the entire web page or image at any given time.

In addition, users often wish to share the contents of their screen with other users. Even if it were possible to clearly display a full webpage or image on the display screen of the device, it may be difficult for several people to gather around the device in such a way that everybody simultaneously has an unobstructed view of the screen. The device often has to be placed at a distance from the users in order for everyone to have a clear view the display, but this comes at the expense of often not being able to view the contents on the display clearly from a distance. Consequently, there is a need for a new and improved method of displaying contents in a larger format than what can be done on a portable device, and in a manner that makes the content more accessible, both to the user of the device, and to anyone with whom they would like to share the content.

### BRIEF DESCRIPTION OF THE DRAWINGS

FIG. 1 shows a method for defining a virtual screen, in accordance with one implementation.

FIG. 2 shows an exemplary architecture of a system for displaying content on a virtual screen, in accordance with one implementation.

FIG. 3 shows a virtual screen generator, in accordance with one implementation.

FIG. 4 shows a virtual screen generator, in accordance with one implementation.

FIG. 5 shows a virtual screen generator, in accordance with one implementation.

Like reference symbols in the various drawings indicate like elements.

### SUMMARY

In some aspects, the techniques described herein relate to a method for creating a virtual screen for displaying a visible image in the air, including: providing a virtual screen generator including one or more light sources, a scanning means for scanning the light from the light sources across a pre-defined space in air, and a controlling means for controlling the operation of the light sources and the scanning means; receiving, by the virtual screen generator, image data to be displayed on the virtual screen; using the controlling means to direct the light from the one or more light sources such that a collection of light-emitting points in the visible range of the electromagnetic spectrum are created within the pre-defined space in the air, wherein the collection of points jointly form an image corresponding to the received image data.

Various embodiments can include one or more of the following features. The image data to be displayed can be an enlarged version of an image shown on a user electronic device, such as a laptop, mobile phone, or tablet computer. The virtual screen generator can be connected to the user electronic device by means of a wired or wireless network.

The one or more light sources can be lasers. The scanning means can include one or more movable mirrors configured to move the light from the light sources across the pre-defined space in air in a raster-like pattern, while switching the light sources on and off to generate brief pulses of light.

The virtual screen generator can include two or more light sources and a scanning means for each light source, and each light source and scanning means can be configured to cover a specific portion of the pre-defined space. The scanning means can include one or more diffractive optical elements or spatial light modulators, and the controlling means can be configured to control the operation of the light sources and the spatial light modulators so as to generate a two-dimensional pattern of light emitting points in the pre-defined space in air.

The pre-defined space in air can be defined by adjusting the focal points of the one or more light sources to create an essentially vertical plane in the air forming the virtual screen. The one or more light sources can operate at a frequency outside the visible range and the light emitting points are generated through plasma discharges in the pre-defined space in air. The virtual screen generator can include a substance emitting means configured to fill the pre-defined space with a non-toxic gaseous medium, in which the light emitting points are generated through fluorescence induced by the light from the one or more light sources. The gaseous medium and the one or more light sources can be selected such that fluorescence occurs at different wavelengths and a virtual screen with multiple colors is generated.

The virtual screen generator can include a substance emitting means configured to fill the pre-defined space with a non-toxic gas-liquid mixture, to provide a reflective virtual screen onto which light of different colors from the one or more light sources can be projected and reflected to an observer. The virtual screen generator can include containment means configured to generate an electric, magnetic or ultrasonic field to essentially confine the substance emitted by the substance emitting means to the pre-defined space in air while displaying the image. The virtual screen generator can include a particle emitter configured to emit small reflective particles into the pre-defined space in the air, and the controlling means can control the movement of the small particles using an electric, magnetic, or ultrasonic field, such that the particles can move around within the pre-defined space in the air, while being illuminated and reflecting light from the one or more light sources to a viewer. The method can include calibrating the virtual screen based on ambient light conditions.

In some aspects, the techniques described herein relate to a system for creating a virtual screen for displaying a visible image in the air, including: a computing device; and a virtual screen generator including one or more light sources, a scanning means for scanning the light from the light sources across a pre-defined space in air, and a controlling means for controlling the operation of the light sources and the scanning means, wherein the virtual screen generator is operable to communicate with the computing device over a network to receive image data to be displayed on the virtual screen, and wherein the virtual screen generator is operable to use the controlling means to direct the light from the one or more light sources such that a collection of light-emitting points in the visible range of the electromagnetic spectrum are created within the pre-defined space in the air, wherein the collection of points jointly form an image corresponding to the received image data.

### DETAILED DESCRIPTION

### Overview

The various implementations of the invention pertain to techniques for defining a “virtual screen,” that is, a two-dimensional area or three-dimensional volume in space, and displaying two-or three-dimensional still or moving images (i.e., video) on that virtual screen. Typically, the images or video correspond to those shown on an electronic device, such as a laptop, mobile phone, tablet computer, etc.

The virtual screen can be operated in any indoor or outdoor environment. However, as the skilled person realizes, the quality of the viewing experience will vary depending on the environment in which the virtual screen is used. For example, the viewing experience will generally be better in an environment with less ambient light (for the same reason that the lights are typically dimmed in a movie theater) or when the “background” is plain and/or contains less movement (i.e., fewer moving cars, people, trees, etc.). The outdoor viewing experience will, as one might expect, also be better during clear weather compared to inclement weather (although it should be noted that fog or haze might under some circumstances enhance the viewing experience), or better in the evening vs. mid-day when there is a lot of ambient light. The virtual screen will, per definition, be transparent, and thus having a less busy background will allow for fewer “distractions” with respect to the content that is being displayed on the virtual screen. This also allows a reduction of the power to the equipment that is used to generate the virtual screen and the images being displayed thereon, and as a result, the battery lifetime can be extended and/or the equipment can be made smaller and more portable.

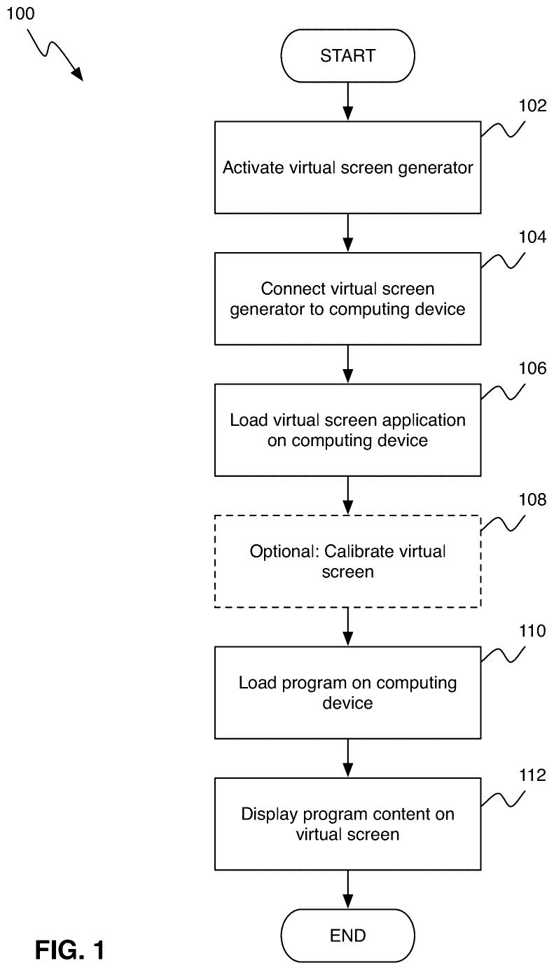

While the virtual screen can be embodied in a number of various implementations, the implementations are operated in accordance with a general method, which will now be described with reference to FIG. 1.

### Exemplary Method for Displaying Content on a Virtual Screen

As can be seen in FIG. 1, a method 100 in accordance with one implementation starts by activating a virtual screen generator, step 102. The virtual screen generator will be described in further detail below, and depending on the particular implementation, the activation may be as simple as flicking an on/off switch, or it may require several steps or setting up various physical components.

Once the virtual screen generator has been activated, the virtual screen generator is connected to a computing device, such as a cell phone, laptop, tablet, or IoT (Internet of Things) enabled device, step 104. Again, depending on the particular implementation at hand, the connection can be wired and/or wireless. The physical location of the computing device can be either far away from, or in close proximity to, the virtual screen generator. In some implementations, the virtual screen generator and the computing device may be integrated into a single device. In other implementations, the virtual screen generator and the computing device may communicate over one or more wired or wireless networks.

Once connection has been established, a virtual screen application is loaded on the computing device, step 106. The virtual screen application contains the instructions for controlling the virtual screen generator to correctly display content. Again, since the virtual screen generator comes in a variety of implementations, typically there will be one virtual screen application associated with each implementation of the virtual screen generator, although different virtual screen applications can also be considered in order for the virtual screen to operate in different modes. The computing device may contain several virtual screen applications and have the capability to download and run further virtual screen applications from the Internet, in order to be usable with a wide variety of virtual screen generators.

Next, the virtual screen is calibrated in an optional step 108. The calibration may be an optional feature on certain virtual screen generators, and can be performed either manually by a user or automatically by the virtual screen generator, possibly in collaboration with the computing device. The purpose of the calibration is to adjust the virtual screen to the environment in which the virtual screen is used. For example, in a low light environment, the virtual screen generator may use less power compared to a bright environment, and still achieve a clearly visible image on the virtual screen. Similarly, generating a virtual screen outdoors during a clear day may require more power from the virtual screen generator compared to a foggy day. Various automatic calibration algorithms can be developed for various conditions, for example, based on obtained measurements of the surrounding environment and/or feedback from prior users' viewing experiences.

Next, a program is loaded on the computing device, step 110. The program typically contains the content that is to be displayed on the virtual screen, and can be essentially any software that can display visual content, such as a web browser, a messaging application, software for displaying online video, drawing software, presentation software, and so on. Essentially anything that may be of interest to be viewed by one or more users.

Finally, the program content is displayed on the virtual screen, step 112. The virtual screen controller receives the program content and instructions from the computing device about how the program content should be displayed on the virtual screen. This ends the process 100.

### General System Architecture

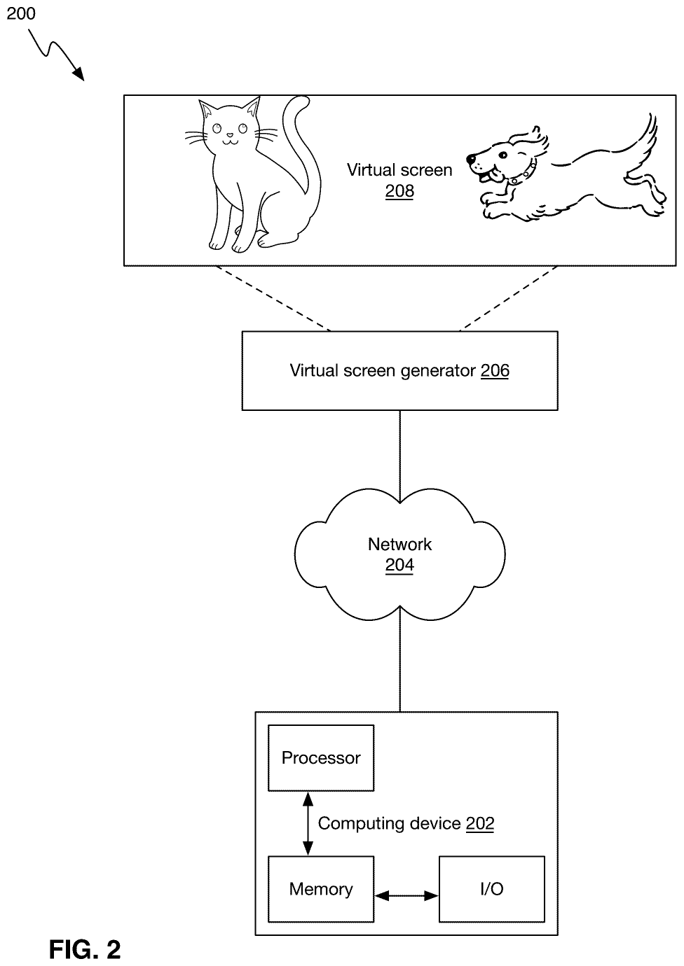

FIG. 2 shows an exemplary architecture of a system 200 for displaying content on a virtual screen, as described above, in accordance with one implementation. As can be seen in FIG. 2, the system 200 includes a computing device 202, which communicates over a network 204 with a virtual screen generator 206 that is used to generate a virtual screen 208 in the air or in some other gaseous or liquid medium, for displaying still and/or moving images. As was noted above, in certain implementations, the computing device 202 and the virtual screen generator 206 are integrated in the same physical unit, and no network 204 is necessary.

As mentioned above, the computing device 202 can be any type of computing device that includes a processor, a memory and some kind of input-output functionality. Typically, the computing device 202 is a portable consumer device, such as a laptop, cell phone, tablet computer, or similar, although in some implementations the computing device 202 can be a stationary computer that is permanently installed in some kind of facility.

In general, a computing device 202 has an input/output (I/O) mechanism coupled to a processor that is coupled to a tangible, non-transitory memory. It should be realized that although FIG. 2 only illustrates one computing device 202, various implementations may also contain one or more auxiliary computing devices and that the invention is not limited to using a single computing device only. The depicted computing device 202 includes instructions, stored in memory, for causing the virtual screen generator 206 to perform any one or more of the methodologies discussed herein.

In some implementations, such as the one shown in FIG. 2, systems of the invention are deployed in a networked deployment and network 204 represents the Internet, a LAN, a Wi-Fi network or a combination thereof. As was discussed above, in certain implementations, systems of the invention are deployed using applications or mobile apps. For example, the computing device 202 can be a hand-held device such as a tablet computer or smart phone capable of operating a mobile app and operating systems of the invention via the mobile app. In other implementations, the computing device 202 can be, as necessary to perform the methodologies described herein, a personal computer (PC), a tablet PC (e.g., iPad, Samsung Galaxy tablet, Nexus 7 tablet computer sold by Google (Mountain View, Calif.), a set-top box (STB), a Personal Digital Assistant (PDA), a cellular telephone or smart phone, a web appliance, a network router, switch or bridge, or any machine capable of executing a set of instructions (sequential or otherwise) that specify actions to be taken by that machine.

In certain implementations, the computing device 202 is a custom device designed and constructed to implement methodologies described herein and is housed, for example, in a unique form-factor or a form-factor not typically associated with laptop, desktop, or tablet computers.

A computing device 202 generally includes one or more input/output (I/O) device, as illustrated in FIG. 2. As was discussed above, the computing device 202 also includes a screen, such as a touchscreen, and other common components, such as a microphone, a speaker, a cellular radio frequency antenna, and a network interface device, which can be, for example, a network interface card (NIC), Wi-Fi card, or cellular modem. The I/O devices generally include ports, WiFi cards, microphone, speaker, touchscreen, etc. and may also in some implementations include the virtual screen generator 306, as will be described below.

A computing device 202 generally includes at least one processor, as shown in FIG. 2. As one skilled in the art would recognize as necessary or best-suited for performance of the methods of the invention, computer systems or machines of the invention include one or more processors (e.g., a central processing unit (CPU) a graphics processing unit (GPU) or both), a main memory and a static memory, which communicate with each other via a bus. One of ordinary skill in the art would also recognize that a processor may be provided by one or more processors including, for example, one or more single core or multi-core processors.

A computing device 202 generally includes memory, also illustrated in FIG. 2. The memory is generally a machine-readable medium and may generally be present in the form of random access memory (RAM), read-only memory (ROM), or a combination thereof. A memory generally refers to one or more storage devices for storing data or carrying information, e.g., semiconductor, magnetic, magneto-optical disks, or optical disks. Information carriers for a memory suitable for embodying computer program instructions and data include any suitable form of memory that is tangible, non-transitory, non-volatile, or a combination thereof. In certain implementations, a device of the invention includes a tangible, non-transitory computer readable medium for memory. Exemplary devices for use as memory include semiconductor memory devices, and flash memory devices, and can be built into, or be external to, the computing device 202. Other examples of memory devices include magnetic disks, (e.g., internal hard disks or removable disks), magneto-optical disks, and optical disks (e.g., CD and DVD disks).

Next, a few examples of virtual screen generators 206 will be described. Generally, the virtual screen generators 206 can be divided into two broad categories; those that generate a passive screen, i.e., a virtual screen upon which light can be projected and reflected or scattered back to the viewer's eyes, and those that generate an active screen, i.e., a virtual screen in which the visible light is created on the screen itself to be observable by the viewer. It should be noted that the examples presented below do in no way form an exhaustive list of virtual screen generators 206, but should be should be considered as illustrative examples of possible implementations. Many modifications can be made of those having ordinary skill in the art. Further, it is also considered to be within the abilities of those having ordinary skill in the art to modify parameters or substitute individual components to enhance the performance of the system and optimize it for particular environments. Thus a wide range of modifications are considered to fall within the scope of the appended claims. Further, it will be noted that while the virtual screen generator 206 and the virtual screen 208 will be presented in the context of air, similar principles can be applied in other gaseous media. Thus, the principles described below are not limited to air only.

### Virtual Screen Generator for Generating Active Plasma Screen

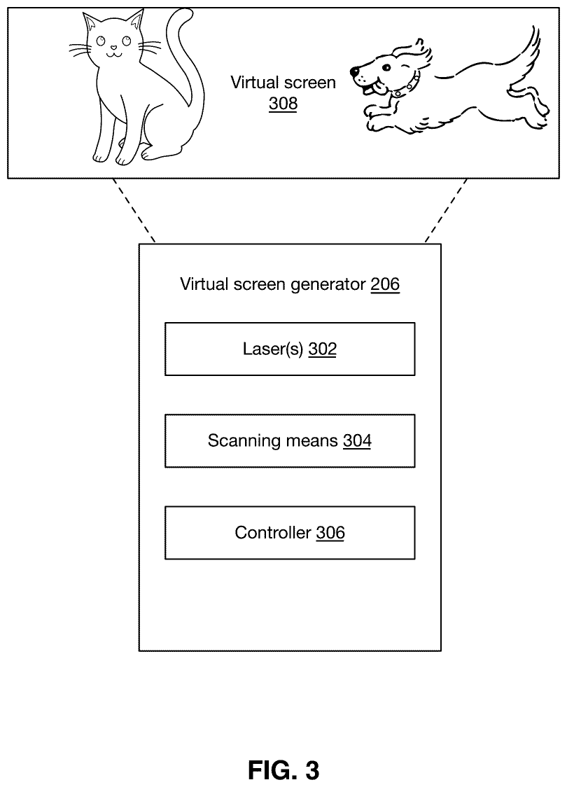

In a first implementation, as shown in FIG. 3, the virtual screen generator 206 includes one or more lasers 302, a scanning means 304 for scanning the lasers across an area that forms the virtual screen 308, and a controller 306 for controlling the individual lasers and the scanning means 304.

When in operation, the controller 306 instructs the scanning means 304, for example, one or more movable mirrors, to move the laser beam in such a way that the laser beam traverses an area corresponding to the virtual screen 308 in a rapid, raster-like pattern, much like to what is done on old fashioned Cathode-Ray Tube (CRT)-type monitors. However, rather than tracing a continuous pattern in the air, the laser 302 switches on and off to generate only a brief pulse at certain times. When the pulsed laser beam is generated, a sufficiently high intensity can lead to a plasma discharge in the air (or in another gas) at a certain point on the virtual screen, which appears to the human eye as a flash of light. With a sufficiently high scanning frequency, the human eye will not distinguish individual flashes of light, but will instead integrate the individual flashes into a pattern forming lines. As a result, “line drawings,” such as the image of the dog and cat shown on the virtual screen 308, can be generated in mid-air. If the virtual screen 308 is too large for a single laser to traverse rapidly enough, several lasers can be used. For example, a first laser may generate the top third of the virtual screen 308, a second laser may generate the middle third of the virtual screen 308, and a third laser may generate the lower third of the virtual screen 308.

In some embodiments, the scanning means 304 could be substituted by diffractive optical elements or spatial light modulators (SLM), which can create a desired two-dimensional pattern on the virtual screen 308 directly without the need of line-by-line scanning, as described above. As is well known in the art, a SLM is an electronically programmable device that can modulate light output based on a specific fixed spatial pattern (pixel), essentially projecting light that is controlled in either amplitude only, phase only or both (phase-amplitude). SLMs are often used in overhead projectors. Since SLMs allow the projected pattern to be changed over time, they are also suitable for purposes of generating moving images on the virtual screen 308.

The distance from the virtual screen generator 306 to the virtual screen 308 (i.e., the “depth” of the screen) can be adjusted by adjusting the focal point of the laser(s), for example, by using various lenses or mirrors, or combinations thereof. By having all plasma discharges occurring at a certain distance from the laser 302, in effect a plane is created that forms the virtual screen 308. In order to not interfere with the flashes of light from the plasma, it is preferable that the laser that is used operates at a frequency that is outside the visible range for humans, such as in the infrared range. Examples of lasers operating in this frequency range include CO2 lasers and Nd:YAG lasers. Being able to adjust the distance, or more generally the position, of the virtual screen 308 from the virtual screen generator 306 may also be important from a safety point of view, such that people or animals do not accidentally enter the area of the virtual screen 308.

In some implementations, a single laser may not be powerful enough by itself to generate plasma in the air. In such a setup, two or more lasers may instead be used in conjunction, such that only when their respective focal points coincide, sufficient power is available to generate plasma in the air. Such a setup requires a more sophisticated control mechanism for the dual lasers, compared to what is needed for a single laser, but may also be advantageous from a safety point of view as the power of each laser can be reduced. Alternatively, some gas (other than air) can be introduced to create the virtual screen 308, in which gas a plasma discharge can occur at a lower intensity compared to what is required for a plasma discharge to occur in air.

In some implementations, various types of prisms can be used to create copies of the virtual screen 208, to be projected at a different location in space, e.g., in two orthogonal directions. The virtual screen generator 206 can also be placed on a moving platform (e.g., rotating), such that the virtual screen 208 can be rotated in space 360 degrees and be viewable from essentially any location, or even to form a virtual screen having a cylindrical or semi-spherical projection “surface,” similar to what can be experience in an Omnimax theater or planetarium or similar.

This plasma-generating implementation may prove very useful for displaying text messages or simple drawings, for example, to provide warning messages or directions to the public. Given the high power that is required for lasers to create plasma in the air, this implementation is particularly suitable for virtual screens that are located some distance away from humans, such as high up in the sky, where no people can interfere with the laser beams. For settings where people may be in closer proximity, there are other, alternative implementations that may be more suitable, as will now be described.

### Virtual Screen Generator for Generating Active Fluorescing Screen

As was mentioned above, there may be situations where it is desirable to create a virtual screen 208 that is located closer to the user and in an environment where other people may be present, and where it therefore may not be practical or safe to have a plasma-based virtual screen 208. In such situations, the virtual screen generator 206 may instead rely on a different physical phenomenon; fluorescence. Fluorescence generally refers to the emission of light by a substance that has absorbed light or other electromagnetic radiation, and emits the light within a short time after absorption. In most cases, the emitted light has a longer wavelength, and therefore a lower photon energy, than the absorbed radiation. A perceptible example of fluorescence occurs when the absorbed radiation is in the ultraviolet region of the spectrum (invisible to the human eye), while the emitted light is in the visible region; this gives the fluorescent substance a distinct color that can only be seen when exposed to ultraviolet (UV) light. In contrast to phosphorescent materials which emit light for some time, fluorescent materials cease to glow nearly immediately when the radiation source stops. Fluorescence can be induced by various types of light sources, such as lasers (so-called Laser-Induced Fluorescence, “LIF”) or Light Emitting Diodes (LEDs). By choosing substances that emit particular desired wavelengths, and choosing light sources (e.g., lasers or LEDs) that can induce fluorescence in those substances, it is possible for the virtual screen generator 206 to generate a color virtual screen 208.

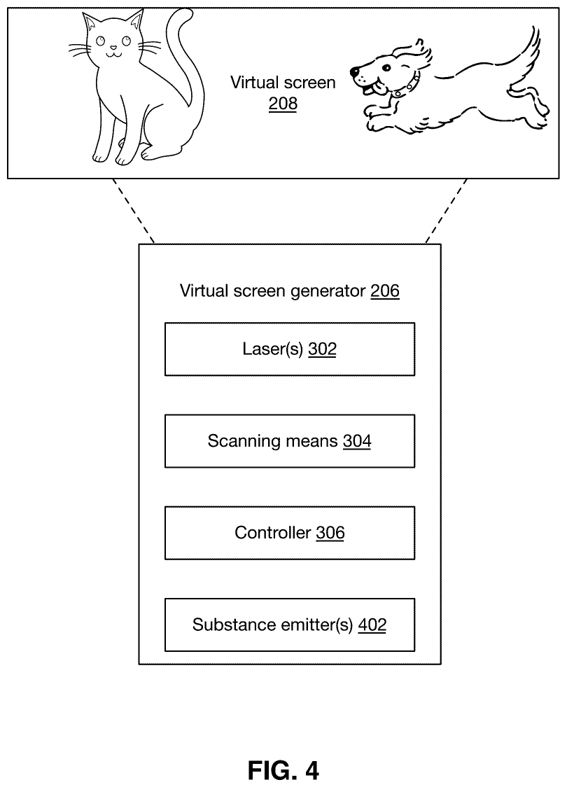

FIG. 4 shows a schematic view of a virtual screen generator 206 for generating a virtual screen 208, which can reproduce a color image using fluorescence. The general operating principles are the same as those described above with respect to the system of FIG. 3 However, in this implementation, the virtual screen generator 306 also includes a substance emitter 402. The substance emitter 402 is configured to release one or more non-toxic gases of the preferred substances into the air, until a sufficient concentration of the substances has been reached for the gasses to emit fluorescent light that is visible to the human eye when illuminated by one or more light sources 404. The light sources 404, can be one or more lasers, LEDs or other suitable sources for exciting the substances and inducing fluorescence.

As an example, consider a scenario in which the virtual screen generator 206 has a substance emitter 402 that contains three different substances; A, B, and C. When illuminated, substance A emits red light, substance B emits green light, and substance C emits blue light. The substance emitter 402 sends out a “cloud” of the three substances, which disperses uniformly in the air close to the substance emitter 402, in effect creating a three dimensional space in which any point can be triggered by its corresponding light source to emit either red, green or blue light. This can essentially be thought of as high resolution virtual screen. When scanning this space, as described above, the red, green and blue light substances at the focal point of the light source(s) can emit light in various combinations, and the human eye will perceive the light similar to how it perceives light from RGB pixels or voxels in conventional displays.

As the light from the light sources 404 will excite any substance it passes through on its way from the virtual screen generator 206 to the virtual screen 208, it is desirable to have a higher concentration of the substances at the location of the virtual screen 208 and a lower concentration of the substances between the light sources 404 and the virtual screen 208, so as to avoid interference from fluorescence outside the virtual screen 308 to the largest possible extent. Various mechanisms, such as electric or magnetic fields or laminar flows, can be used to accomplish such a containment or concentration difference of the substances in space. Furthermore, there is of course no limitation as to the colors to red, green and blue. As gases can fluoresce in a very large number of wavelengths, essentially any combination of colors can be generated using this implementation of the virtual screen generator 306, which may provide a much richer color experience for the viewer compared to one that is limited to various combinations of red, green and blue.

### Virtual Screen Generator for Generating Passive Screen using Liquid-Gas Mixture

This implementation of the virtual screen generator 206 is similar to the screen generator 206 described above for generating a fluorescing virtual screen 208. However, rather than emitting a gas, the substance emitter 402 emits a gas-liquid mixture, such as an aerosol or mist. The location of this liquid-gas mixture can be controlled, for example, using some kind of electromagnetic field, ultrasound, or fans creating a laminar flow, or by controlling the nozzles releasing the liquid-gas mixture, such that only a certain size of droplets are released in certain desired directions, etc.

As a result, a virtual screen 208 is created that has a higher density compared to the surrounding air, and therefore also reflects light. The virtual screen 208 can therefore be illuminated with one or more lasers 302 having one or more different colors, and the light will reflect off the virtual screen 308 and reach the viewer's eyes. A similar effect can be observed when driving a car on a foggy day, but as the virtual screen generator 206 has the ability to control properties of both the “mist” itself (e.g., droplet size and/or color) and the light that is used to illuminate the mist, it is possible to provide virtual screens 208 having varying qualities, rather than just a “white wall” of reflected light.

### Virtual Screen Generator for Generating Passive Screen using Moving Particles

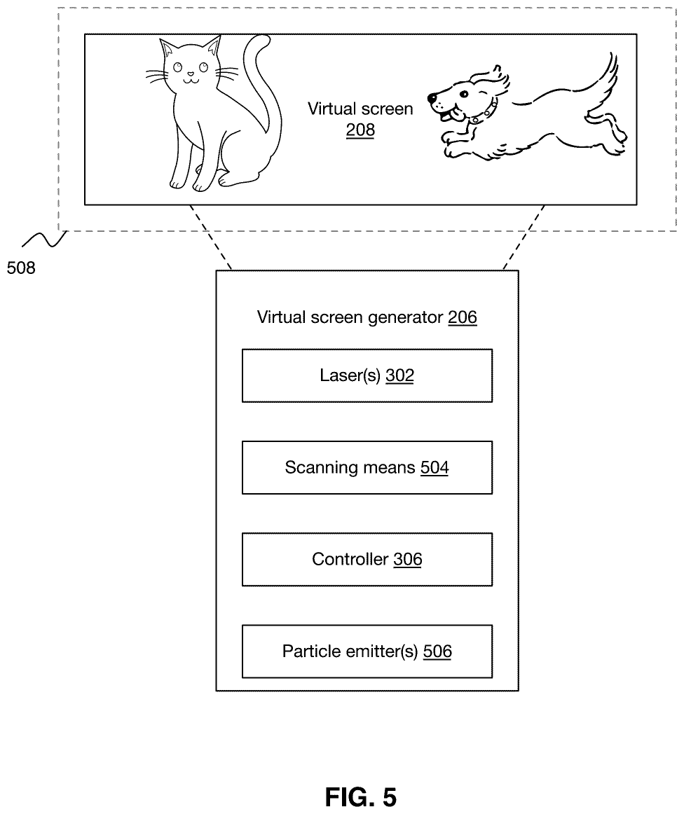

In this implementation, which is schematically shown in FIG. 5, the virtual screen generator 206 includes one or more lasers 302, a scanning means 504, a controller 306 for controlling the individual lasers and the scanning means 504, and a particle emitter 506.

This implementation is based on the concept that a small particle can be suspended and controlled in air, either by light or by sound, to move the particle in a very precise manner around a three-dimensional space. The particle can be a solid particle made of, for example, plastic, metal, or be a droplet of some type of liquid, such as oil. When in operation, the controller 306 instructs the scanning means 504, to move the particle in such a way that “outlines” a shape in space. If the particle changes positions quickly enough, the human eye will “integrate” the positions of the particle into a line, rather than discrete positions, much similar to what was described above with the implementation presented in FIG. 3.

In addition, the particle can be illuminated by lasers, which reflects light back to the eyes of the observer, and which will cause the particle to appear colored. For example, a white particle tracing the outline of a square could be illuminated by a red laser while drawing the top and bottom lines of the square, and by a green laser while drawing the sides of the square, resulting in a red-green square to the observer's eye. Thus, in this implementation, not only is the particle controlled by the scanning means 504, but the scanning means 504 also control one or more lasers, similar to what has been described above.

Further, since it is possible to control the movement of the particle in any direction, of course the particle can also be made to traverse an area corresponding to the virtual screen 208 in a rapid, raster-like pattern, as was described above, and be illuminated by specific colors at specific positions. Similar to the plasma and fluorescence implementations described above, the particle movement will be integrated by the eyes of the human observer, so it will appear to form lines, which may blend together into a color picture.

If the virtual screen 208 is too large for a single particle to traverse quickly enough, several particles can be used and independently controlled. For example, a first particle may generate the top third of the virtual screen 208, a second particle may generate the middle third of the virtual screen 208, and a third particle may generate the lower third of the virtual screen 208.

Taking these techniques even one step further, in some implementations, tens, hundreds, or even thousands of small particles can be used, and rather than being moved in a raster-like fashion, they can be arranged and rearranged in various patterns by an acoustic field (e.g., an acoustic wave, similar to what can be seen when sand is placed on a vibrating drum) or an electrical and/or magnetic field, or standing waves resulting from an electrical and/or magnetic field, or various combinations thereof. It should also be noted that all the particles do not need to be of the same kind, but a mix of different particles can be provided, which respond differently to different types of fields. Some of these mixes may contain certain particles that only respond to an acoustic field, and other particles that respond to electric/magnetic fields only. Thus, different fields can control different particles, and as a result, more intricate patterns can be generated. Further, while the particles have been described as having reflective properties, it should be realized that the particles themselves may also emit light, which may reduce or completely avoid the use of light sources, such as the lasers 302 of FIG. 5. Many variations can be envisioned by those having ordinary skill in the art.

As the skilled person further realizes, if a particle is suspended in air and being controlled by light, sound, or by electric or magnetic fields, the particle is by definition very light. This also makes the particle very susceptible to disturbances around the particle, such as gusts of air (outdoors as well as indoors). Therefore, to prevent dropping of the particle, an optional encasing 508 can be provided which may be placed around the area of the virtual screen 208, when the virtual screen generator 206 is used in an environment that may be subject to these types of disturbances. Such an encasing 508 can be made of essentially any transparent material that allows the light reflected from the particle reach the observer's eyes. In some implementations, the encasing 508 can also aid in the generation of an electric and/or magnetic field to keep the particles suspended and counteract the effects of gravity. Preferably, the encasing 508 is collapsible such that a user easily can carry it along with the computing device 202.

In yet another, related implementation, the moving particles can be embodied as a “waterfall” of small droplets of water or other type of liquid, which move under the influence of gravity. This waterfall again provides a surface onto which light can be projected and reflected back to the viewer's eyes. Typically, the width and height of the waterfall defines the size of the virtual screen 208. Similarly to the aerosol described above, varying the size and color of the droplets can produce the desired virtual screen qualities. For example, the waterfall can be comprised of 512 or 1024 parallel vertical “lines.”

### Virtual Screen Generator for Generating Passive Screen using Hologram Images

One implementation of the virtual screen generator 206 uses concepts known from the general field of holography to create a virtual screen 208. Conventionally, holograms are generated by shining part of a light beam (the reference beam), from a laser, say, directly onto a recording medium, and shining the other part of the light beam (the illumination beam or object beam) onto an object in such a way that some of the scattered light also falls onto the recording medium. Several different materials can be used as the recording medium. One of the most common materials is a film, which is very similar to photographic film (silver halide photographic emulsion), but has a much higher concentration of light-reactive grains, making it capable of the much higher resolution that holograms require.

When the two laser beams reach the recording medium, their light waves intersect and interfere with each other, and the interference pattern is imprinted on the recording medium. The pattern itself is seemingly random, as it represents the way in which the scene's light interfered with the original light source-but not the original light source itself. The interference pattern on the recording medium can be considered an encoded version of the scene, requiring a particular key-the original light source-in order to view its contents. This missing key is later provided later by shining a laser, identical to the one used to record the hologram, onto the developed film. When this beam illuminates the hologram, it is diffracted by the hologram's surface pattern. This produces a light field identical to the one originally produced by the scene and scattered onto the hologram, appearing as a virtual image of the object to a viewer.

The virtual screen generator 206 in this implementation uses the same basic principles, but rather than having an interference pattern recorded on a physical medium, the computing device 202 generates an artificial interference pattern on its display, corresponding to the image that is intended to be shown in the virtual screen 208. This will cause the virtual screen to be formed in the air at a certain distance from the display of the computing device 202. So when in use, a user would typically place their computing device 202 onto a table or some other surface, and then the virtual screen 208 would appear above the computing device 202 and be visible for several viewers. It should be noted that this implementation works for both still and moving images, in which case the interference pattern would be dynamically generated by the computing device.

It should be noted, however, that a prerequisite for this implementation is to have a computing device with a display that is capable of controlling the phase of the light from the display, such that interference can be achieved in a variety of directions. Otherwise, the limitations of the display may also limit the possible viewing angles for the users that are attempting to view the contents of the virtual screen 208. In general, a two-dimensional virtual screen 208 is simpler to generate than a three-dimensional virtual screen in this aspect.

Virtual screen generator for generating passive screen using three-or four-wave mixing

The underlying concept for this type of virtual screen generator 206 is referred to as three-or four-wave mixing, and is related to the hologram implementation described above in the sense that it uses similar underlying concepts. However, rather than generating an interference pattern using a computing device, an optical setup is used which allows three or four waves to interfere in a non-linear optical medium, such as a gas. Three- and four-wave mixing, respectively, occur in different materials, depending on whether there is a second or third order non-linearity, respectively. In materials having a second order (i.e., quadratic) non-linearity, two waves interact to create a third wave (hence, three-wave mixing) and in materials having third order (i.e., cubic) non-linearity, three waves interact to create a fourth wave (hence, four-wave mixing).

In four-wave mixing, two pump waves (also called reference waves) interact with an object wave to form a conjugate wave from two pump photons having the same or different frequencies. A special case of four-wave mixing also exists, in which only a single pump wave is used. This special case is referred to as degenerate four-wave mixing.

Many variations can be envisioned, but in essence, the general idea is that one or several waves interact via a material nonlinearity (e.g., in a gas) to create new light via three-or four-wave mixing. This new light is visible to an observer and gives the appearance of a virtual screen 208, much like what is done in a holographic setup.

### Concluding Comments

It should be noted that the above examples are merely intended to illustrate a few possible use scenarios and that the general principles of the invention are applicable to a number of different areas, ranging from navigation applications, to advertising, to displaying warning/security messages, informational presentations, entertainment purposes (movies, gaming, etc.), i.e., essentially anything that “conventional displays” can perform today. Further, based on the available space and particular implementation of virtual screen generator, the size of the virtual screen may vary from anywhere between a few inches in diameter to several feet or even yards in diameter.

Also, while the above description has been limited to a two-dimensional virtual screen, it should be noted that there may be various ways to extend these concepts to three-dimensional, volumetric virtual screens, by applying similar general principles in a depth dimension as technology improves. In such an implementation, the contents on the virtual display would be viewable from any direction, thus allowing users to gather around all sides of the virtual screen, which may be particularly useful in a presentation or entertainment setting. Thus, the implementations described herein should not be considered as limited to two-dimensional screens only.

Further, various types of optical components (e.g., lenses, prisms, beam splitters, mirrors, SLMs, etc.) can be combined with the techniques described above, to modify the size, shape and appearance of the virtual screen 208, or how it is perceived by a user. Various technologies from adjacent areas, such as HUD (Head Up Displays), can be combined with the various implementations described herein to further enhance the implementations described above. Such modifications lie well within the abilities of those having ordinary skill in the art.

Lastly, in addition to the above mentioned physical processes, there are other processes in which light can interact with matter to alter its wavelength. For example, in addition to plasma, fluorescence, and three-or four-wave mixing, so-called Raman scattering or Brillouin scattering can change the wavelength of incoming light. These physical phenomena can be used in conjunction with the various embodiments described above, as altering the wavelength can be a useful component in generating a virtual screen 308.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), application-specific integrated circuits (ASIC) or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for creating a virtual screen for displaying a visible image in the air, comprising:
providing a virtual screen generator comprising one or more light sources a scanning means for scanning the light from the light sources across a pre-defined space in air, and a controlling means for controlling the operation of the light sources and the scanning means;
receiving, by the virtual screen generator, image data to be displayed on the virtual screen;
using the controlling means to direct the light from the one or more light sources such that a collection of light-emitting points in the visible range of the electromagnetic spectrum are created within the pre-defined space in the air, wherein the collection of points jointly form an image corresponding to the received image data.

2. The method of claim 1, wherein the image data to be displayed is an enlarged version of an image shown on a user electronic device, such as a laptop, mobile phone, or tablet computer.

3. The method of claim 2, wherein the virtual screen generator is connected to the user electronic device by means of a wired or wireless network

4. The method of claim 1, wherein the one or more light sources are lasers.

5. The method of claim 1, wherein the scanning means comprises one or more movable mirrors configured to move the light from the light sources across the pre-defined space in air in a raster-like pattern, while switching the light sources on and off to generate brief pulses of light.

6. The method of claim 1, wherein the virtual screen generator comprises two or more light sources and a scanning means for each light source, and wherein each light source and scanning means is configured to cover a specific portion of the pre-defined space.

7. The method of claim 1, wherein the scanning means comprises one or more diffractive optical elements or spatial light modulators, and the controlling means is configured to control the operation of the light sources and the spatial light modulators so as to generate a two-dimensional pattern of light emitting points in the pre-defined space in air.

8. The method of claim 1, wherein the pre-defined space in air is defined by adjusting the focal points of the one or more light sources to create an essentially vertical plane in the air forming the virtual screen.

9. The method of claim 1, wherein the one or more light sources operates at a frequency outside the visible range and the light emitting points are generated through plasma discharges in the pre-defined space in air.

10. The method of claim 1, wherein the virtual screen generator further includes a substance emitting means configured to fill the pre-defined space with a non-toxic gaseous medium, in which the light emitting points are generated through fluorescence induced by the light from the one or more light sources.

11. The method of claim 10, wherein the gaseous medium and the one or more light sources are selected such that fluorescence occurs at different wavelengths and a virtual screen with multiple colors is generated.

12. The method of claim 1, wherein the virtual screen generator further includes a substance emitting means configured to fill the pre-defined space with a non-toxic gas-liquid mixture, to provide a reflective virtual screen onto which light of different colors from the one or more light sources can be projected and reflected to an observer.

13. The method of claim 10, wherein the virtual screen generator further comprises containing means configured to generate an electric, magnetic or ultrasonic field to essentially confine the substance emitted by the substance emitting means to the pre-defined space in air while displaying the image.

14. The method of claim 1, wherein the virtual screen generator further comprises a particle emitter configured to emit small reflective particles into the pre-defined space in the air, and wherein the controlling means is further operable to control the movement of the small particles using an electric, magnetic, or ultrasonic field, such that the particles can move around within the pre-defined space in the air, while being illuminated and reflecting light from the one or more light sources to a viewer.

15. The method of claim 1, further comprising calibrating the virtual screen based on ambient light conditions.

16. A system for creating a virtual screen for displaying a visible image in the air, comprising:
a computing device; and
a virtual screen generator comprising one or more light sources, a scanning means for scanning the light from the light sources across a pre-defined space in air, and a controlling means for controlling the operation of the light sources and the scanning means,
wherein the virtual screen generator is operable to communicate with the computing device over a network to receive image data to be displayed on the virtual screen, and
wherein the virtual screen generator is operable to use the controlling means to direct the light from the one or more light sources such that a collection of light-emitting points in the visible range of the electromagnetic spectrum are created within the pre-defined space in the air, wherein the collection of points jointly form an image corresponding to the received image data.
